(19) United States
(12) Patent Application Publication
(10) Pub. No.: US 2025/0139469 A1
(43) Pub. Date: May 1, 2025

(54) EVALUATION METHOD

(71) Applicant: SCREEN Holdings Co., Ltd., Kyoto (JP)

(72) Inventor: Takeru NAKAMURA, Kyoto (JP)

(21) Appl. No.: 18/922,655

(22) Filed: Oct. 22, 2024

(30) Foreign Application Priority Data
Oct. 30, 2023 (JP) 2023-185702

(51) Int. Cl. G06N 5/04

(52) U.S. Cl. CPC G06N 5/04

(57) ABSTRACT

There is provided an evaluation method for evaluating the validity of inference results outputted by a machine learning model. This evaluation method includes the steps of: extracting specific data from the inference results outputted by the machine learning model (Steps S11 to S13); and performing factor analysis of the machine learning model on the specific data (Steps S21 and S22). This allows the validity of the machine learning model which outputs inference results from sensor data to be efficiently checked without performing factor analysis on all inference results.

### RELATED APPLICATIONS

This application claims the benefit of Japanese Application No. 2023-185702, filed on Oct. 30, 2023, the disclosure of which is incorporated by reference herein.

### BACKGROUND OF THE INVENTION

### Field of the Invention

The present invention relates to a technique for evaluating the validity of inference results outputted by a machine learning model.

### Description of the Background Art

In recent years, predictive maintenance, abnormality detection, failure factor

analysis, and the like have been performed for various industrial apparatuses by using various types of sensor data and machine learning to predict and estimate apparatus conditions. When machine learning is applied to industrial apparatuses in this manner, there has been a problem in that the basis for judgment and the relationship between inputs and outputs are unknown because a large number of machine learning models are black boxes.

To solve such a problem, a technique known as explainable AI has been used to interpret how inference results are derived. For example, Japanese Patent Application Laid-Open No. 2023-5037 discloses a factor analysis device including a factor calculation part and a factor visualization part. This factor analysis device allows a user to visually grasp a factor that contributes to inference results.

On the other hand, if an attempt is made to verify all input data and output inference results for a machine learning model when verifying whether the inference results of the machine learning model are valid or not, the amount of data to be verified is enormous. This has made it difficult to verify whether the machine learning model is properly learned or not.

### SUMMARY OF THE INVENTION

In view of the foregoing, it is therefore an object of the present invention to provide a technique for efficiently checking the validity of a machine learning model that outputs inference results from sensor data.

To solve the aforementioned problem, a first aspect of the present invention is intended for a method of evaluating the validity of inference results outputted by a machine learning model, which comprises the steps of: a) extracting specific data from the inference results outputted by the machine learning model; and b) performing factor analysis of the machine learning model on the specific data.

A second aspect of the present invention is intended for the method of the first aspect, wherein the machine learning model outputs the inference results as time-series data, based on time-series data inputted thereto, and wherein the step a) includes the steps of: a1) predicting the inference results from past data about the inference results; a2) comparing predicted results of the step a1) with the inference results outputted from the machine learning model to calculate a predictive error; and a3) extracting the specific data from the inference results by using the predictive error.

A third aspect of the present invention is intended for the method of the second aspect, wherein the inference results are predicted using an autoregressive model or a deep learning model in the step a1).

A fourth aspect of the present invention is intended for the method of the second aspect, wherein the inference results for which the absolute value of the predictive error is not less than a threshold value are extracted as the specific data in the step a3).

A fifth aspect of the present invention is intended for the method of the fourth aspect, wherein the threshold value is three times the standard deviation of the predictive error.

A sixth aspect of the present invention is intended for the method of any one of the first to fifth aspects, wherein explainable AI is used for the factor analysis in the step b).

A seventh aspect of the present invention is intended for the method of the sixth aspect, wherein the explainable AI is SHAP.

An eighth aspect of the present invention is intended for the method of the seventh aspect, wherein a comparison is made in the step b) between a SHAP value of each factor in the specific data and a SHAP value of each factor in the inference results that are not the specific data.

A ninth aspect of the present invention is intended for the method of the eighth aspect, wherein the SHAP value of each factor in the specific data and the SHAP value of each factor in the inference results that are not the specific data are displayed in heat map format.

According to the first to ninth aspects of the present invention, the validity of the machine learning model is efficiently checked.

In particular, according to the sixth to ninth aspects of the present invention, the use of the explainable AI facilitates the factor analysis for the evaluation of the machine learning model.

In particular, according to the ninth aspect of the present invention, the factor analysis is further facilitated because the SHAP values of respective factors are visually comparable.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an example of an apparatus for application;

FIG. 2 shows an example of sensor positions during a learning process of a machine learning model;

FIG. 3 is a block diagram showing functions of a computer;

FIG. 4 is a diagram showing inputs and outputs of the machine learning model;

FIG. 5 is a flow diagram showing a procedure for an evaluation method of the machine learning model;

FIG. 6 shows an example of predictive errors; and

FIG. 7 shows an example of heat maps of SHAP values.

### DESCRIPTION OF THE PREFERRED EMBODIMENTS

A preferred embodiment according to the present invention will now be described with reference to the drawings.

### 1. Example of Apparatus to Which Machine Learning Model Is Applied

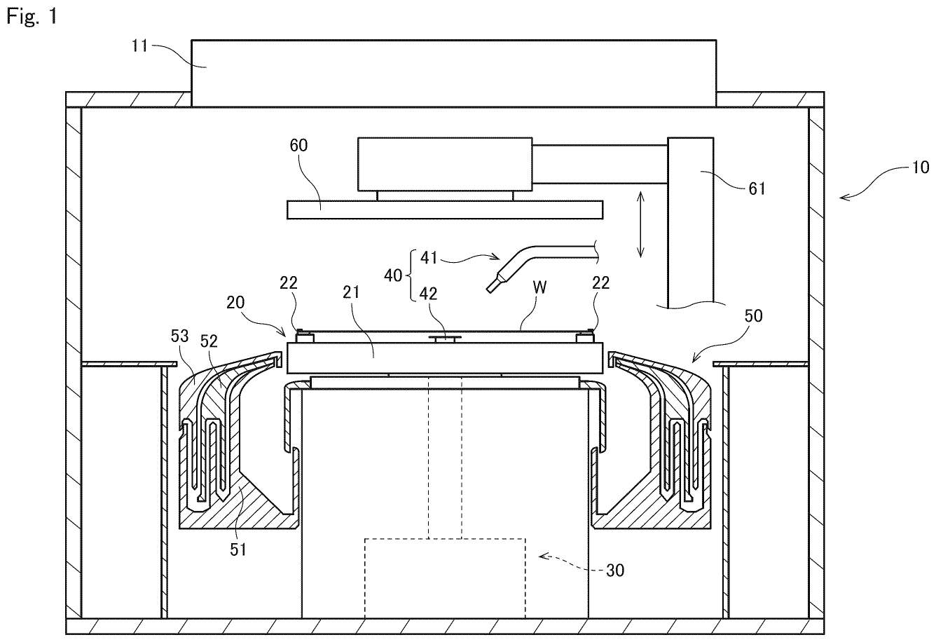

First, a substrate processing apparatus 1 will be described as an example of apparatuses to which a machine learning model M to be evaluated for the validity of inference results in an estimation method of the present invention is applied. FIG. 1 is a schematic view of the substrate processing apparatus 1 as an example of the apparatuses to which the machine learning model is applied.

The substrate processing apparatus 1 is an apparatus which supplies a processing liquid to a surface of a substrate W that is a disk-shaped silicon wafer to process the surface of the substrate W in the process steps of manufacturing a semiconductor wafer. As shown in FIG. 1, the substrate processing apparatus 1 includes a chamber 10, a substrate holding part 20, a rotation mechanism 30, a processing liquid supply part 40, a processing liquid collection part 50, and a shield plate 60. The substrate holding part 20, the rotation mechanism 30, the processing liquid supply part 40, the processing liquid collection part 50, and the shield plate 60 are housed in the chamber 10.

The chamber 10 forms a processing space for processing the substrate W. A gas flow supply part 11 for supplying a downward gas flow is provided in an upper portion of the chamber 10.

The substrate holding part 20 is a mechanism for holding the substrate W in a horizontal attitude inside the chamber 10. The substrate holding part 20 includes a disk-shaped spin base 21 and a plurality of chuck pins 22. The chuck pins 22 hold a peripheral portion of the substrate W, and position the substrate W, with a slight gap from an upper surface of the spin base 21. The rotation mechanism 30 is a mechanism for rotating the substrate holding part 20.

The processing liquid supply part 40 is a mechanism for supplying a processing liquid to upper and lower surfaces of the substrate W held by the substrate holding part 20. The processing liquid supply part 40 includes an upper surface nozzle 41 for supplying the processing liquid to the upper surface of the substrate W and a lower surface nozzle 42 for supplying the processing liquid to the lower surface of the substrate W.

The processing liquid collection part 50 is a mechanism for collecting the processing liquid after use. The processing liquid collection part 50 includes an inner cup 51, an intermediate cup 52, and an outer cup 53 which are connected to different liquid outlet channels. The inner cup 51, the intermediate cup 52, and the outer cup 53 are upwardly and downwardly movable independently of each other by an elevating mechanism not shown between a lower position in which an upper end thereof is positioned below the substrate W and an upper position in which an upper end thereof is positioned above the upper surface of the substrate W. In FIG. 1, the inner cup 51, the intermediate cup 52, and the outer cup 53 are all shown as located in the lower position.

During the processing of the substrate W, the processing liquid supply part 40 supplies the processing liquid to the surface of the substrate W while the rotation mechanism 30 rotates the substrate holding part 20 and the substrate W, with any one of the three cups 51, 52, and 53 of the processing liquid collection part 50 located in the upper position. After being supplied to the surface of the substrate W and performing a surface processing of the substrate W, the processing liquid is splashed outwardly by centrifugal force due to the rotation of the substrate W, collected by any one of the three cups 51, 52, and 53 of the processing liquid collection part 50, and collected through a corresponding liquid outlet channel.

The shield plate 60 is a member for suppressing the diffusion of gas near the surface of the substrate W when some processes such as a drying process of the substrate W after the supply of the processing liquid are performed. The shield plate 60 has a disk-shaped outline, and is disposed in a horizontal attitude over the substrate holding part 20. The shield plate 60 is connected to an elevating mechanism 61. When the elevating mechanism 61 is operated, the shield plate 60 is moved upwardly and downwardly between an upper position which is spaced upwardly apart from the upper surface of the substrate W held by the substrate holding part 20 and a lower position which is closer to the upper surface of the substrate W than the upper position.

During the supply of the processing liquid from the processing liquid supply part 40 to the substrate W, the shield plate 60 is retracted to the upper position. During the drying process of the substrate W after the supply of the processing liquid, the shield plate 60 is moved downwardly to the lower position by the elevating mechanism 61. Then, dry gas is blown from an outlet not shown toward the upper surface of the substrate W. At this time, the shield plate 60 prevents the gas from diffusing. As a result, the dry gas is efficiently supplied to the upper surface of the substrate W.

### 2. Machine Learning Model

Next, the machine learning model M for estimating a gas flow near the substrate W will be described for the aforementioned substrate processing apparatus 1. An estimation method according to the present invention may be used, for example, to evaluate the validity of inference results of this machine learning model M.

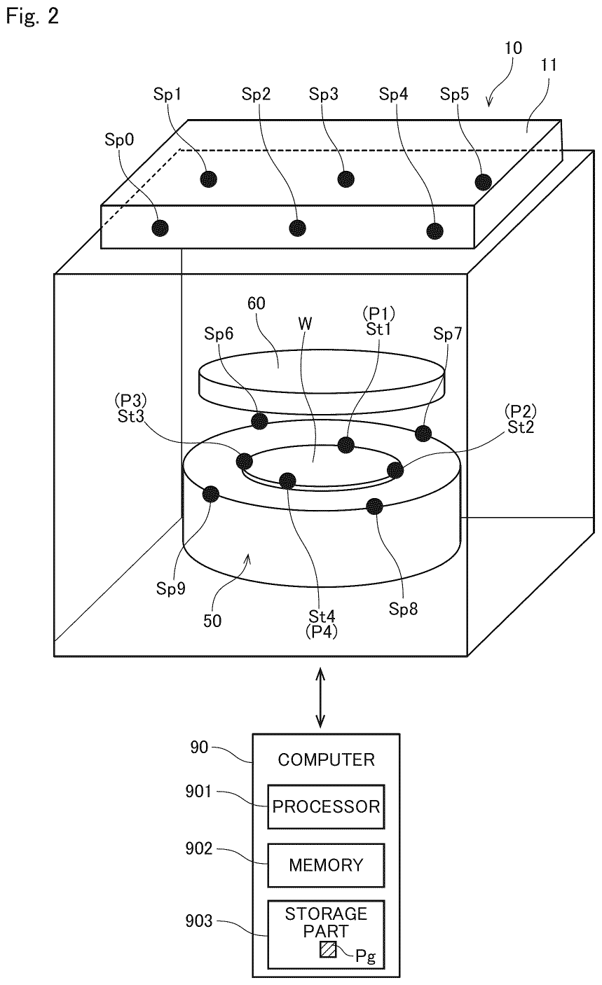

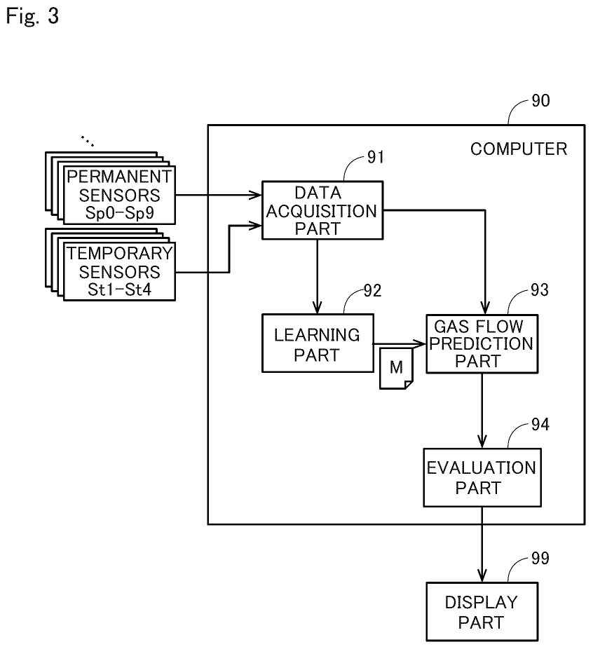

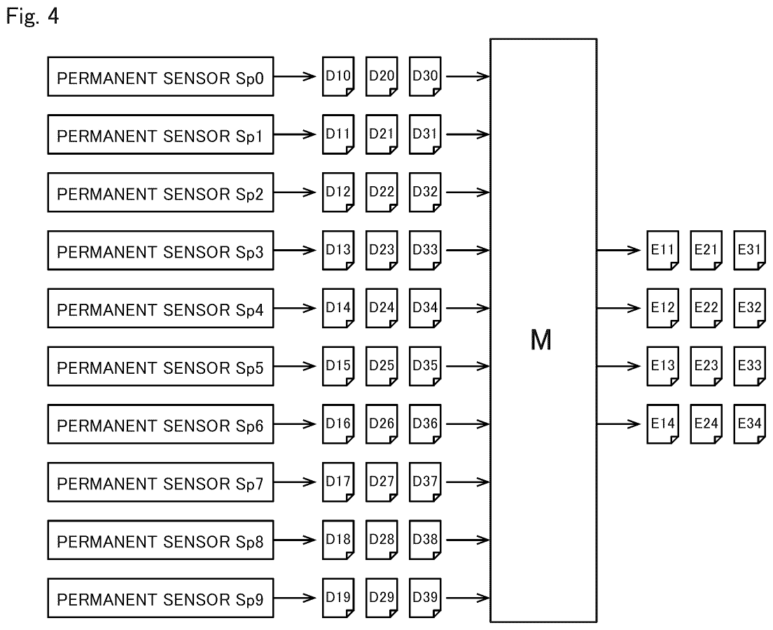

This machine learning model M estimates the gas flow near the substrate W from time-series data detected by a plurality of gas flow sensors provided in the substrate processing apparatus 1. FIG. 2 shows an example of sensor positions during a learning process of the machine learning model M. FIG. 3 is a block diagram showing functions of a computer 90 which executes the learning process of the machine learning model M, a gas flow prediction process around the substrate W by means of the machine learning model M during the substrate processing in the substrate processing apparatus 1, and an evaluation process for the machine learning model M. FIG. 4 is a diagram showing inputs and outputs of the machine learning model M.

As shown in FIG. 2, the substrate processing apparatus 1 includes ten permanent sensors Sp0, Sp1, Sp2, Sp3, Sp4, Sp5, Sp6, Sp7, Sp8, and Sp9 installed in the chamber 10. During the learning process of the machine learning model M, four temporary sensors St1, St2, St3, and St4 are installed at four points P1, P2, P3, and P4, respectively, around the substrate W near which the gas flow is to be estimated. The permanent sensors Sp0 to Sp9 and the temporary sensors St1 to St4 each measure the three values of wind velocity, azimuth angle, and depression angle at respective points.

Time-series data about wind velocity detected by the permanent sensors Sp0 to Sp9 are referred to hereinafter as wind velocity data D10 to D19, respectively. Time-series data about azimuth angle detected by the permanent sensors Sp0 to Sp9 are referred to hereinafter as azimuth angle data D20 to D29, respectively. Time-series data about depression angle detected by the permanent sensors Sp0 to Sp9 are referred to hereinafter as depression angle data D30 to D39, respectively.

Likewise, time-series data about wind velocity detected by the temporary sensors St1 to St4 are referred to hereinafter as wind velocity data D41 to D44, respectively. Time-series data about azimuth angle detected by the temporary sensors St1 to St4 are referred to hereinafter as azimuth angle data D51 to D54, respectively. Time-series data about depression angle detected by the temporary sensors St1 to St4 are referred to hereinafter as depression angle data D61 to D64, respectively.

The aforementioned values detected by the permanent sensors Sp0 to Sp9 and the temporary sensors St1 to St4 are inputted to the computer 90.

The computer 90 is an information processing device for executing the learning process of the machine learning model M, the gas flow prediction process around the substrate W by means of the machine learning model M during the substrate processing in the substrate processing apparatus 1, and the evaluation process for the machine learning model M. The computer 90 is electrically connected to the substrate processing apparatus 1. The computer 90 accepts at least the detected values of the permanent sensors Sp0 to Sp9 and the temporary sensors St1 to St4, and outputs gas flow prediction results around the substrate W outputted by the machine learning model M or control values based on the gas flow prediction results to the substrate processing apparatus 1. The computer 90 may also serve as a controller for controlling the substrate processing apparatus 1.

As conceptually shown in FIG. 2, the computer 90 includes a processor 901 such as a CPU, a memory 902 such as a RAM, and a storage part 903 such as a hard disk drive. A computer program Pg for executing the learning process of the machine learning model M, the gas flow prediction process around the substrate W by means of the machine learning model M during the substrate processing in the substrate processing apparatus 1, and the evaluation process for the machine learning model M is stored in the storage part 903.

As shown in FIG. 3, the computer 90 includes a data acquisition part 91, a learning part 92, a gas flow prediction part 93, and an evaluation part 94. The functions of the data acquisition part 91, the learning part 92, the gas flow prediction part 93, and the evaluation part 94 are implemented by the processor 901 of the computer 90 operating in accordance with the computer program Pg.

During the learning process of the machine learning model M, with the temporary sensors St1 to St4 installed in the chamber 10, the permanent sensors Sp0 to Sp9 and the temporary sensors St1 to St4 measure the gas flow in the chamber 10 to input the measurements to the data acquisition part 91 of the computer 90 without supplying the processing liquid in the substrate processing apparatus 1. Then, the data acquisition part 91 transfers the detection results of the permanent sensors Sp0 to Sp9 and the temporary sensors St1 to St4 to the learning part 92.

The learning part 92 uses the wind velocity data D10 to D19, the azimuth angle data D20 to D29, and the depression angle data D30 to D39 which are detected by the permanent sensors Sp0 to Sp9 as input variables and uses the wind velocity data D41 to D44, the azimuth angle data D51 to D54, and the depression angle data D61 to D64 which are detected by the temporary sensors St1 to St4 as training data to perform machine learning of the machine learning model M.

Thus, as shown in FIG. 4, the machine learning model M becomes an estimation model using the wind velocity data D10 to D19, the azimuth angle data D20 to D29, and the depression angle data D30 to D39 which are detected by the permanent sensors Sp0 to Sp9 as input variables to output estimated wind velocities E11 to E14, estimated azimuth angles E21 to E24, and estimated depression angles E31 to E34 at the four points P1 to P4. It should be noted that the estimated wind velocities E11 to E14, the estimated azimuth angles E21 to E24, and the estimated depression angles E31 to E34 are time-series data.

When the learning process of the machine learning model M is completed, the machine learning model M after the learning is transferred to the gas flow prediction part 93. Before the start of the substrate processing in the substrate processing apparatus 1, the temporary sensors St1 to St4 are removed. The gas flow at the four points P1 to P4 cannot be detected by the temporary sensors St1 to St4 during the substrate processing. In other words, the gas flow around the substrate W cannot be detected during the substrate processing. For this reason, the state of the gas flow at the four points P1 to P4 around the substrate W during the substrate processing is estimated by the machine learning model M.

While the substrate processing is being performed in the substrate processing apparatus 1, the values detected by the permanent sensors Sp0 to Sp9 are always inputted to the data acquisition part 91 of the computer 90 and transferred to the gas flow prediction part 93. The gas flow prediction part 93 uses the wind velocity data D10 to D19, the azimuth angle data D20 to D29, and the depression angle data D30 to D39 which are detected by the permanent sensors Sp0 to Sp9 as input variables to output the estimated wind velocities E11 to E14, the estimated azimuth angles E21 to E24, and the estimated depression angles E31 to E34 at the four points P1 to P4. Then, these inference results are outputted to the substrate processing apparatus 1.

After the start of the operation of the machine learning model M, it is difficult to check the validity of the outputs (E11 to E14, E21 to E24, and E31 to E34) which are inference results thereof against the actual measurement results because the temporary sensors St1 to St4 have been removed. For this reason, an evaluation method to be described below is used to evaluate the validity of the inference results outputted by the machine learning model M.

### 3. Evaluation Method of Machine Learning Model

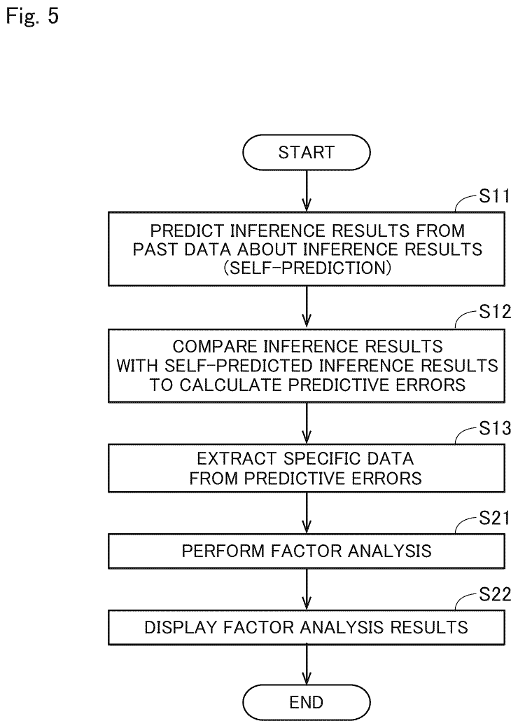

FIG. 5 is a flow diagram showing a procedure for the evaluation method of the machine learning model M. As shown in FIG. 5, this evaluation method includes the steps of: extracting specific data from the inference results outputted by the machine learning model M (Steps S11 to S13); and performing factor analysis on the inference results of the machine learning model M extracted as the specific data (Steps S21 and S22).

In the evaluation method of FIG. 5, the evaluation part 94 initially acquires the inference results (E11 to E14, E21 to E24, and E31 to E34) outputted from the gas flow prediction part 93. Then, the evaluation part 94 predicts the inference results themselves from past data about the inference results to acquire self-predicted inference results (Step S11). Specifically, the evaluation part 94 predicts the 12 values of the estimated wind velocities E11 to E14, the estimated azimuth angles E21 to E24, and the estimated depression angles E31 to E34 themselves, which are the inference results of the machine learning model M, from time-series past data. For example, when input and output values of the machine learning model M are time-series data per second, the value of the next estimated wind velocity E11 is predicted based on the past data 20 to 1 second before about the estimated wind velocity E11.

In the present preferred embodiment, a VAR model (Vector Auto Regressive model) is used for the self-prediction in Step S11. However, other autoregressive models such as AR models and ARMA models, and deep learning models such as LSTM and Transformer may be used for the self-prediction in Step S11.

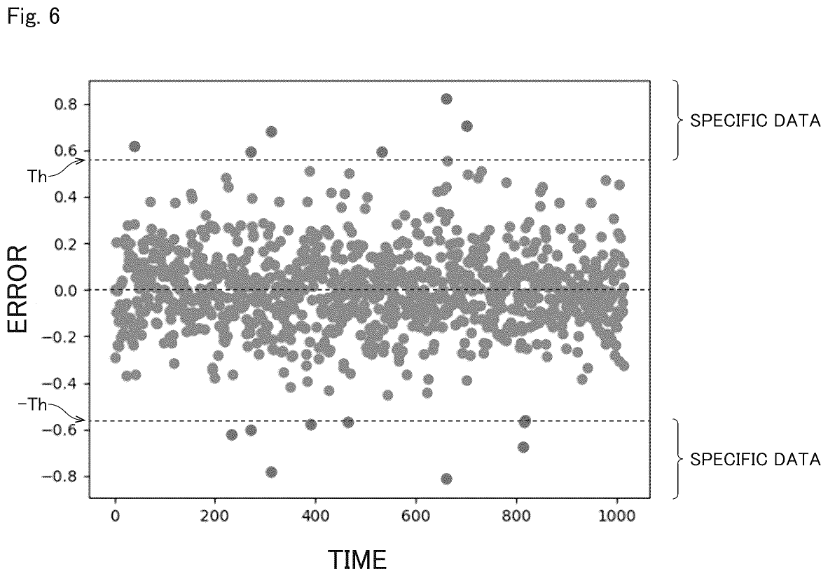

Subsequent to Step S11, the evaluation part 94 compares the inference results outputted from the machine learning model M with the self-predicted inference results obtained in Step S11 to calculate predictive errors (Step S12). FIG. 6 shows an example of the predictive errors of the estimated wind velocity E11. A predictive error of the estimated wind velocity E11 is specifically an error between the estimated wind velocity E11 outputted from the machine learning model M and the self-predicted result predicted from the past data about the estimated wind velocity E11. In FIG. 6, the abscissa represents substrate processing time, and the ordinate represents the predictive errors. As shown in FIG. 6, the predictive errors of the estimated wind velocity E11 are distributed around zero.

After calculating the predictive errors, the evaluation part 94 uses these predictive errors to extract the specific data from the inference results (Step S13). Specifically, the evaluation part 94 extracts the inference results for which the absolute value of the predictive error is not less than a threshold value as the specific data. In the example of FIG. 6, the threshold value Th is three times the standard deviation of the predictive errors.

In this manner, the evaluation part 94 uses the self-predicted inference results to extract the specific data on which the validity of the inference results are to be checked. This efficiently reduces the amount of data that needs to be checked in detail by a user.

After extracting the specific data in Steps S11 to S13, the evaluation part 94 subsequently performs the factor analysis on each of the specific data (Step S21). Specifically, the evaluation part 94 uses explainable AI to analyze the contribution of each input variable to the inference results of the machine learning model M. In the present preferred embodiment, SHAP (SHapley Additive explanations) is used for the explainable AI. Thus, a SHAP value for each input variable is outputted from the SHAP in Step S21. In this manner, the use of the explainable AI facilitates the factor analysis for the evaluation of the machine learning model M.

Subsequently, the evaluation part 94 displays the SHAP value for each input variable obtained in Step S21 on a display part 99 connected to the computer 90 (Step S22). This allows the user to visually analyze the factors responsible for the decrease in prediction accuracy in the specific data and to evaluate the machine learning model M.

In Step S21, the factor analysis may also be performed for the inference results that are not the specific data, and a comparison may be made between the SHAP value of each factor in the specific data and the SHAP value of each factor in the inference results that are not the specific data. In that case, the SHAP value of each factor in the specific data and the SHAP value of each factor in the inference results that are not the specific data may be displayed in heat map format and compared with each other in Step S22. The comparison in the heat map format facilitates the factor analysis and the evaluation of the machine learning model M.

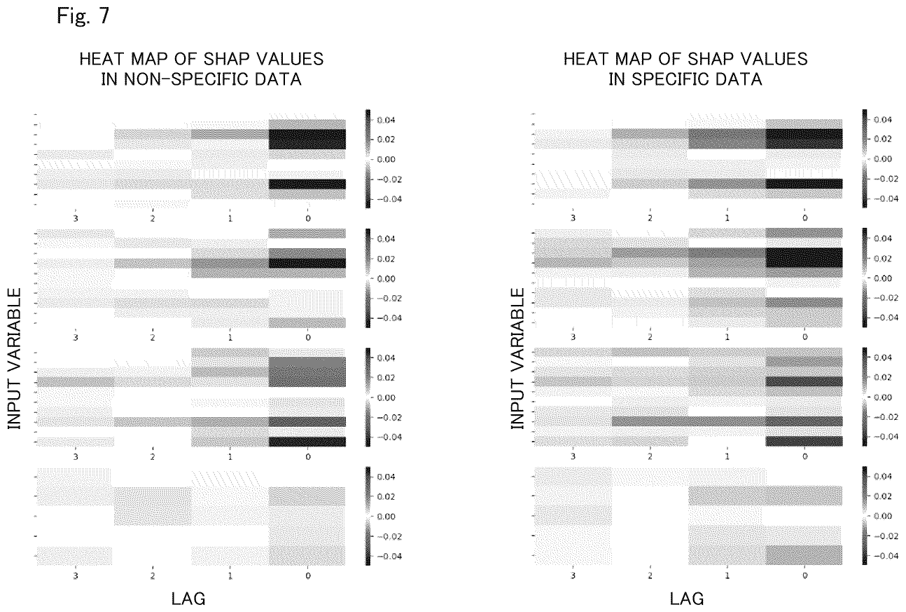

FIG. 7 shows an example of the heat maps of the SHAP values in the specific data and non-specific data. In the heat maps of FIG. 7, the ordinate represents input variables, and the abscissa represents lag. In FIG. 7, “lag=0” represents first previous past data, “lag=1” represents second previous past data, “lag=2” represents third previous past data, and “lag=3” represents fourth previous past data. In the present preferred embodiment, the past data with lag=0 is the past data 1 second before. As shown in FIG. 7, the heat maps make it easier to visually compare the SHAP values in the specific and non-specific data. This further facilitates the factor analysis.

### 4. Modifications

While the one preferred embodiment according to the present invention has been described hereinabove, the present invention is not limited to the aforementioned preferred embodiment.

In the aforementioned preferred embodiment, the machine learning model M to be evaluated is for the estimation of the gas flow near the substrate W in the substrate processing apparatus 1. The present invention, however, is not limited to this. The machine learning model to be evaluated may be used in other apparatuses, such as printing apparatuses or image processing apparatuses, which receive some sensor detection results as an input and provide some inference results as an output. Also, the machine learning model to be evaluated need not necessarily be used in some type of apparatus.

The components described in the aforementioned preferred embodiment and in the modifications may be consistently combined together, as appropriate.

While the invention has been shown and described in detail, the foregoing description is in all aspects illustrative and not restrictive. It is therefore understood that numerous modifications and variations can be devised without departing from the scope of the invention.

What is claimed is:

1. A method of evaluating the validity of inference results outputted by a machine learning model, comprising the steps of:
a) extracting specific data from said inference results outputted by said machine learning model; and
b) performing factor analysis of said machine learning model on said specific data.

2. The method according to claim 1,
wherein said machine learning model outputs said inference results as time-series data, based on time-series data inputted thereto, and
wherein said step a) includes the steps of:
a1) predicting said inference results from past data about said inference results;
a2) comparing predicted results of said step a1) with said inference results outputted from said machine learning model to calculate a predictive error; and
a3) extracting said specific data from said inference results by using said predictive error.

3. The method according to claim 2,
wherein said inference results are predicted using an autoregressive model or a deep learning model in said step a1).

4. The method according to claim 2,
wherein said inference results for which the absolute value of said predictive error is not less than a threshold value are extracted as said specific data in said step a3).

5. The method according to claim 4,
wherein said threshold value is three times the standard deviation of said predictive error.

6. The method according to claim 1,
wherein explainable AI is used for the factor analysis in said step b).

7. The method according to claim 6,
wherein said explainable AI is SHAP.

8. The method according to claim 7,
wherein a comparison is made in said step b) between a SHAP value of each factor in said specific data and a SHAP value of each factor in said inference results that are not said specific data.

9. The method according to claim 8,
wherein the SHAP value of each factor in said specific data and the SHAP value of each factor in said inference results that are not said specific data are displayed in heat map format.
